(19) United States
(12) Patent Application Publication
(10) Pub. No.: US 2025/0374865 A1
(43) Pub. Date: Dec. 11, 2025

(54) WORK TOOL DRIVE UNIT FOR A CUTTING BLADE OF A HANDHELD WORK APPARATUS, AND HANDHELD WORK APPARATUS HAVING THE WORK TOOL DRIVE UNIT

(71) Applicant: Andreas Stihl AG & Co. KG, Waiblingen (DE)

(72) Inventors: Tobias Reichle, Stuttgart (DE); Lars Härtenstein, Leinfelden-Echterdingen (DE); Björn Petersen, Grossbottwar (DE); Markus Nefzger, Winnenden (DE)

(21) Appl. No.: 19/228,555

(22) Filed: Jun. 4, 2025

(30) Foreign Application Priority Data
Jun. 7, 2024 (DE) 10 2024 115 954.5

(51) Int. Cl. A01G 3/053; A01G 3/04; F16H 37/12; F16H 57/02; F16H 57/031

(52) U.S. Cl. CPC A01G 3/053; F16H 37/124; F16H 57/031; A01G 2003/0461; F16H 2057/02034; F16H 2057/02073

(57) ABSTRACT

A work tool drive unit for a cutting blade of a handheld work apparatus includes an electric motor configured to rotate a drive pinion, a gearbox, a planetary gear arranged in the gearbox, with a single ring gear, a single planetary carrier and planets driven by the drive pinion, an eccentric shaft driven by the planetary gear and is configured to drive at least one cutting tool. The planets each have a first peripheral section and a second peripheral section. The first peripheral section is in engagement exclusively with the drive pinion, and the second peripheral section is in engagement exclusively with the ring gear. The work tool drive unit has an oscillating weight which is connected fixedly to the drive pinion for conjoint rotation.

### CROSS-REFERENCE TO RELATED APPLICATIONS

This application claims priority of German patent application no. 10 2024 115 954.5, filed Jun. 7, 2024, the entire content of which is incorporated herein by reference.

### TECHNICAL FIELD

The disclosure relates to a work tool drive unit for a cutting blade of a handheld work apparatus, and to a handheld work apparatus with the work tool drive unit.

### BACKGROUND

Work tool drive units for cutting blades of handheld work apparatuses, such as hedge trimmers, are known in various embodiments in the prior art. A common feature of all of them is the conversion of a continuous rotational movement of the electric motor into an oscillating movement of the at least one driven cutting blade by an eccentric gear. A second cutting blade can be arranged in a stationary manner or can likewise be driven. The cutting blade usually either has a slotted guide, into which a cam of the eccentric shaft engages, or a connecting rod is arranged between the blade and the cam. The rotational movement of the eccentric shaft is converted into a to and fro movement of the at least one driven cutting blade. Depending on the work task, there are different requirements made of cutting frequency and cutting energy. The cutting frequency is limited towards higher values, since the material to be cut no longer manages to fall into the opening cutting gap at an excessively high cutting frequency.

In the course of the electrification of hedge trimmers, higher drive rotational speeds are provided than by way of a conventional internal combustion engine. Planetary gears require less installation space in comparison with spur gears, in order to provide the same transmission ratio. Therefore, single-stage or multiple-stage planetary gears are increasingly used to reduce the high drive rotational speeds. High transmission ratios can be realized by way of multiple-stage planetary gears, but they are considerably heavier than single-stage planetary gears on account of their at least two sets of ring gears, planetary carriers and planets. Therefore, relatively long use of the work apparatus can be perceived to be unergonomic. In addition, the costs for the gear and its assembly are increased by the multiplicity of components.

Although single-stage planetary gears have a lower weight than multiple-stage planetary gears, they are sometimes not capable of achieving a sufficiently high step-down transmission ratio in the same radial installation space, in order to ensure the cutting material falls into the cutting gap even at a high drive rotational speed. As a result of the surrounding apparatus housing, the diameter of the ring gear cannot be increased as desired, in order to increase the transmission ratio as a result.

The higher the moment of inertia and the angular velocity of the rotating gear elements, the more energy can be stored in the drive train. This is significant, in particular, for work tool drive units for cutting tools which are driven in an oscillating manner, since they have a varying velocity/force or torque profile. Depending on the thickness, hardness and time of the cutting material falling into the cutting gap, the cutting tools tend to jam if the cutting energy which can be applied at this time is not sufficient to sever the material to be cut. The performance of the work apparatus can be increased by energy stored in the drive train. Therefore, high rotational speeds of rotating masses are expedient for the performance of the work apparatus. On the other hand, the work tool drive unit should also, however, be as light as possible, in order to make ergonomic working using the work apparatus possible.

A further challenge is the loading of the bearing positions of the planets of the first or single planetary stage on the planetary carrier at very high drive rotational speeds. The higher the drive rotational speed of a drive pinion which drives the planets, the more rapidly the planets run around the drive pinion, and the higher the centrifugal forces which act on the planets. In the case of planets which are mounted on the planetary carrier in a floating manner, in particular, it can occur that the planets can detach at excessively high drive rotational speeds. In order to ensure reliable operation of the work apparatus, the bearing positions of the planets on the planetary carrier are to be strengthened in the case of even higher drive rotational speeds.

### SUMMARY

It is therefore an object to specify a work tool drive unit for a cutting blade of a handheld work apparatus, and a handheld work apparatus with a work tool drive unit which is compact and light and at the same time has high performance.

This object is achieved with regard to the work tool drive unit for a cutting blade of a handheld work apparatus. The work tool drive unit includes: an electric motor configured to rotate a drive pinion at a drive rotational speed; a gearbox; a planetary gear arranged in the gearbox and the planetary gear including a single ring gear, a single planetary carrier and planets driven by the drive pinion; an eccentric shaft driven by the planetary gear at an output rotational speed and being configured to drive at least one cutting tool in an oscillating manner; the planets each having a first peripheral section and a second peripheral section; wherein a first diameter of the first peripheral section is greater than a second diameter of the second peripheral section; wherein the first peripheral section is in engagement exclusively with the drive pinion and the second peripheral section is in engagement exclusively with the ring gear; and, an oscillating weight connected fixedly to the drive pinion for conjoint rotation.

As a result of the difference in diameter of the first peripheral section and the second peripheral section, a greater transmission ratio can be realized in an identical radial installation space with regard to a rotational axis of the drive pinion than by way of a single-stage planetary gear. A single-stage planetary gear denotes a planetary gear with a single ring gear, a single planetary carrier and planets which are in engagement by way of the same peripheral section both with the ring gear and with the planetary carrier.

By virtue of the fact that the planets each have a first peripheral section and a second peripheral section, and a first diameter of the first peripheral section is greater than a second diameter of the second peripheral section, and the first peripheral section is in engagement exclusively with the drive pinion, and the second peripheral section is in engagement exclusively with the ring gear, the circulating speed, at which the planets run in the ring gear, is reduced in comparison with an embodiment, in which there is either no first peripheral section and the drive pinion is in engagement with the second peripheral section, or there is no second peripheral section and the ring gear is in engagement with the first peripheral section.

In this way, the centrifugal forces which act on the bearing system of the planets are reduced. By virtue of the fact that a lower circulating speed of the planets at an identical drive rotational speed of the drive pinion can be realized by way of the change in diameter of the planet, the drive rotational speed of the drive pinion can be increased further even without strengthening the bearing system of the planets, until the identical centrifugal forces bear on the planet as previously.

By virtue of the fact that the planetary gear has merely a single ring gear and a single planetary carrier, it is lighter than planetary gears with a plurality of sets of ring gears and planetary carriers. Although this is advantageous for the ergonomics, the inertial energy in the system is also reduced as a result. According to the disclosure, an oscillating weight is connected fixedly to the drive pinion for conjoint rotation; as a result, the oscillating weight experiences the maximum angular velocity present in the system.

A fixed connection for conjoint rotation is understood to mean a positively locking and/or integrally joined and/or non-positive indirect or direct connection of two parts, which connection does not permit a relative rotation of the two parts. Two sections which are configured integrally on one component are likewise considered to be connected fixedly to one another for conjoint rotation.

By virtue of the fact that the square of the angular velocity goes into the stored rotational energy and the omitted weights do not rotate at the drive rotational speed, an oscillating weight with a lower mass than the mass of the omitted rotating weights is sufficient, when considered in a simplified manner, to provide comparable rotational energy.

By virtue of the fact that the drive rotational speed of the drive pinion can also be increased even further on account of the stepped planets without strengthening the bearing positions of the planets, the energy which can be stored can selectively be increased even further in the case of an identical oscillating weight, in order to obtain an even more powerful work apparatus, or the mass of the oscillating weight can be reduced, in order to obtain an even lighter work apparatus.

The oscillating weight can be formed completely or partially by the rotor itself in the case of an electric motor which is configured as an external rotor motor. The rotor is, in particular, connected fixedly to the drive pinion for conjoint rotation. In addition or as an alternative, further oscillating weights can be connected fixedly to the drive pinion for conjoint rotation. It is provided in an embodiment that the drive pinion has a third peripheral section and a fourth peripheral section, wherein the fourth peripheral section of the drive pinion is in engagement with the first peripheral section of the planet, and wherein the third peripheral section of the drive pinion has a diameter which is increased in comparison with the fourth peripheral section of the drive pinion, and the third peripheral section forms the oscillating weight, at least partially.

This embodiment is particularly effective if the motor is configured as an internal rotor motor, and the rotor of the electric motor therefore itself has only a low mass moment of inertia, in comparison with a corresponding external rotor motor. The drive pinion is, in particular, connected to the rotor in a non-positive and/or positively locking manner. In this way, depending on the work apparatus to be produced, the oscillating weight can be selected to be greater or smaller. The third peripheral section and the fourth peripheral section can be configured integrally with one another. As a result, the oscillating weight of the third peripheral section and the toothed fourth peripheral section of the drive pinion are connected to one another in a particularly durable manner. In addition, an overlap of the rotor and the drive pinion can be reduced. It can also be provided that the third peripheral section and the fourth peripheral section are joined to one another indirectly or directly, for example are pressed or adhesively bonded. As an alternative, it can also be provided for the oscillating weight to be configured separately from the drive pinion, with the result that the drive pinion and the oscillating weight are connected separately to the rotor. In this way, a fixed connection of the oscillating weight and the drive pinion for conjoint rotation is also realized even if this is more complicated.

In an embodiment, the electric motor, the planetary gear and the eccentric shaft are arranged coaxially with respect to one another. That is, a rotational axis of the electric motor, a central axis of the planetary gear which coincides with the rotational axis of the drive pinion, and a rotational axis of the eccentric shaft lie coaxially with respect to one another. The drive pinion is arranged on the rotor of the electric motor. A particularly compact construction can be achieved in this way. In particular, the gearbox has a pot-shaped gear receiving chamber and a cover, wherein the cover covers the gear receiving chamber in an axial direction, and, in particular, the electric motor is arranged on the cover, in particular is mounted thereon. As a result, a work tool drive unit can be provided which is finally assembled per se. Additional bearing positions of the electric motor on the housing of the handheld work apparatus can be dispensed with. In this way, vibratory decoupling of the work tool drive unit from the remaining work apparatus can take place in a particularly simple way.

The terms radial and axial always refer, unless explicitly indicated otherwise, to the rotational axis, about which the drive pinion rotates.

A through opening, through which the eccentric shaft protrudes, is configured in a base of the pot-shaped gear receiving chamber. On its circumference, the eccentric shaft supports at least one cam for driving the at least one driven cutting blade. The cam can be configured integrally on the eccentric shaft or can be connected fixedly to the eccentric shaft for conjoint rotation by other known joining methods. The eccentric shaft can be configured integrally with the planetary carrier. The base of the gear receiving chamber can be formed, for example, by a collar which projects from a circumferential wall of the gear receiving chamber or by a securing ring which is inserted in a peripheral groove of the circumferential wall. The ring gear is supported, in particular, firstly in the axial direction on the base of the gearbox and secondly in the axial direction on the cover of the gearbox. If, in particular, the drive pinion has a third peripheral section, the spacing between the cover and the ring gear becomes greater. In an embodiment, a hold-down is arranged between the cover and the ring gear, in order to bridge the spacing. Even if a third peripheral section is not arranged on the drive pinion, a hold-down which is configured separately from the cover can be expedient, in order to fix the ring gear axially. The hold-down can be annular. It can also be provided that a plurality of, in particular at least three, individual hold-downs are arranged between the ring gear and the cover. A combination of a thin ring with discrete thicker positions can also be provided. The hold-down is produced, in particular, from a material with a lower density than the cover, in particular a plastic material, with the result that the weight of the non-rotating components is reduced further. It can also be provided that one or more projections are configured integrally on the ring gear on an end face of the ring gear which faces the cover, which projections form the at least one hold-down. This is particularly advantageous if the ring gear is manufactured from a plastic material. In this way, the ring gear and the hold-down can be produced inexpensively together, in particular in an injection molding method.

The ring gear has, in particular, radially outwardly protruding projections, by way of which it is supported in the peripheral direction on axially running grooves of the circumferential wall. The, in particular, plurality of hold-downs are expediently arranged in the grooves, in particular completely in the grooves, of the circumferential wall. In this way, the first diameter of the first peripheral section of the planets can be maximized and can protrude as far as close to the internal diameter of the pot-shaped gear chamber. It is ensured at the same time that the hold-downs have a sufficient thickness, in order not to buckle in the case of axial loading.

In an embodiment, the ring gear has a fifth peripheral section and a sixth peripheral section, wherein the fifth peripheral section is in engagement with the second peripheral sections of the planets, and a bearing position for a planetary carrier of the planetary gear is arranged on the sixth peripheral section. This concept is an independent inventive concept. The concept is, in particular, independent of the configuration of the planets with a first peripheral section and a second peripheral section and/or the number of stages of the planetary gear. An axial minimum length of the ring gear is required for secure mounting of the ring gear in the gearbox. The axial minimum length ensures that the ring gear does not fracture at the toothing, and the ring gear is centered reliably in the gearbox. It has been determined, however, that the axial length of the toothing can be smaller than the axial minimum length of the ring gear. In order to realize a construction which is as compact as possible, a sixth peripheral section, on which a bearing position for mounting the planetary carrier indirectly via the ring gear on the gearbox is supported, has been configured on the ring gear in addition to the fifth peripheral section which supports the toothing. In this way, the axial minimum length of the ring gear is utilized firstly for the first peripheral section, that is, the toothing, and secondly the sixth peripheral section, that is, the support of the planetary carrier. The fifth peripheral section and the sixth peripheral section can have, in particular, different diameters. For particularly robust mounting of the planetary carrier, the sixth peripheral section has, in particular, a greater diameter than the fifth peripheral section. An embodiment of this type is particularly expedient if the bearing system of the planetary carrier at the same time forms a bearing position of the eccentric shaft. The forces which occur on the cutting blades during cutting are then likewise to be absorbed by the sixth peripheral section of the ring gear.

The base of the gear receiving chamber is adjoined by a blade chamber, in which the cutting blades are arranged. At least one cutting blade is driven directly or indirectly by the cam of the eccentric shaft. In particular, two cams which are arranged in an opposed manner are arranged on the eccentric shaft, with the result that two cutting blades are driven in an opposed manner with respect to one another.

In an embodiment, the transmission ratio of the planetary gear lies in a value range between 4 and 13, in particular between 7 and 10. A particularly advantageous ratio of installation space and weight is achieved as a result.

In an embodiment, the gearbox has a substantially cylindrical circumferential wall with an internal diameter and a length which is measured in the axial direction, wherein the length is at most 50%, in particular at most 45%, of the internal diameter, and the internal diameter lies radially outside a cam which is arranged on the eccentric shaft. That is, the gearbox takes up at least the radial installation space which is taken up in any case by a cam during operation. In return, the gearbox is of particularly flat construction in the axial direction. A reduced axial length of the gearbox brings it about that the center of gravity of the gear moves closer to the movement plane of the cutting blades. This improves the handleability, in particular maneuverability, of the work apparatus. This is particularly advantageous if the electric motor is arranged on the gearbox in the axial direction.

In an embodiment, the first peripheral section and the second peripheral section of the planet are configured in one piece. A reliable transmission of torque between the two peripheral sections is ensured by the single-piece configuration of the first peripheral section and the second peripheral section. The correct orientation of the toothing of the first peripheral section and the second peripheral section with respect to one another is also ensured as a result. In particular, the first peripheral section and the second peripheral section are produced together in a shaping method such as, for example, sintering or injection molding. As a result, planets with peripheral sections of different diameters can be produced inexpensively, with the result that use in a work tool drive unit for a work apparatus is economical. An anti-friction bearing for attaching the planet to the planetary carrier extends within the planet, in particular over the two peripheral sections.

### BRIEF DESCRIPTION OF DRAWINGS

The invention will now be described with reference to the drawings wherein:

FIG. 1 shows a perspective view of a work apparatus with a work tool drive unit according to the disclosure,

FIG. 2 shows a longitudinal section through the work tool drive unit of the work apparatus from FIG. 1 along the sectional line II-Il in FIG. 3,

FIG. 3 shows a detailed view of the region Z from FIG. 2,

FIG. 4 shows a cross section through the work tool drive unit of the work apparatus from FIG. 1 along the sectional line IV-IV in FIG. 2; and,

FIG. 5 shows a side view of the work apparatus from FIG. 1 in a partially assembled state.

### DETAILED DESCRIPTION

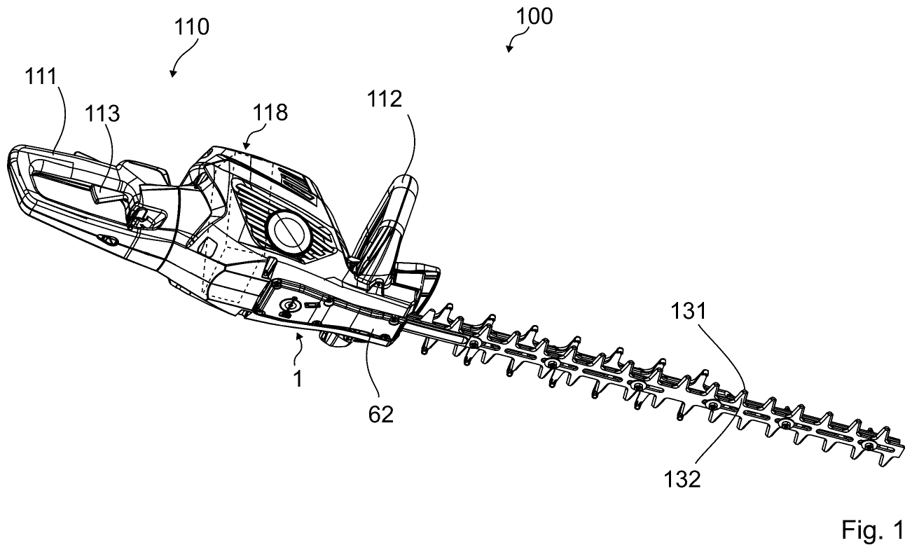

FIG. 1 shows a handheld work apparatus 100 in an embodiment as a hedge trimmer. The work apparatus 100 includes a handle unit 110 for holding and guiding the work apparatus 100, and a work tool drive unit 1 for driving the cutting blade of the work apparatus 100. In the embodiment, a first handle 111 with an operator controlled element 113 for controlling the work tool drive unit 1 and a second handle 112 are arranged on the handle unit 110, between which handles a receptacle 118 (shown using dashed lines) for a rechargeable battery pack which can be removed without tools is configured as energy source 120 for the work tool drive unit 1. The receptacle 118 can also be arranged at other positions of the handle unit 110, in particular below the rear first handle 111 which is remote from the tool. The rechargeable battery pack can be arranged completely within the receptacle 118 or can protrude completely or partially out of it. The work tool drive unit 1 is connected to the handle unit 110 via anti-vibration elements (not shown). A rigid attachment of the work tool drive unit 1 to the handle unit 110 is also possible.

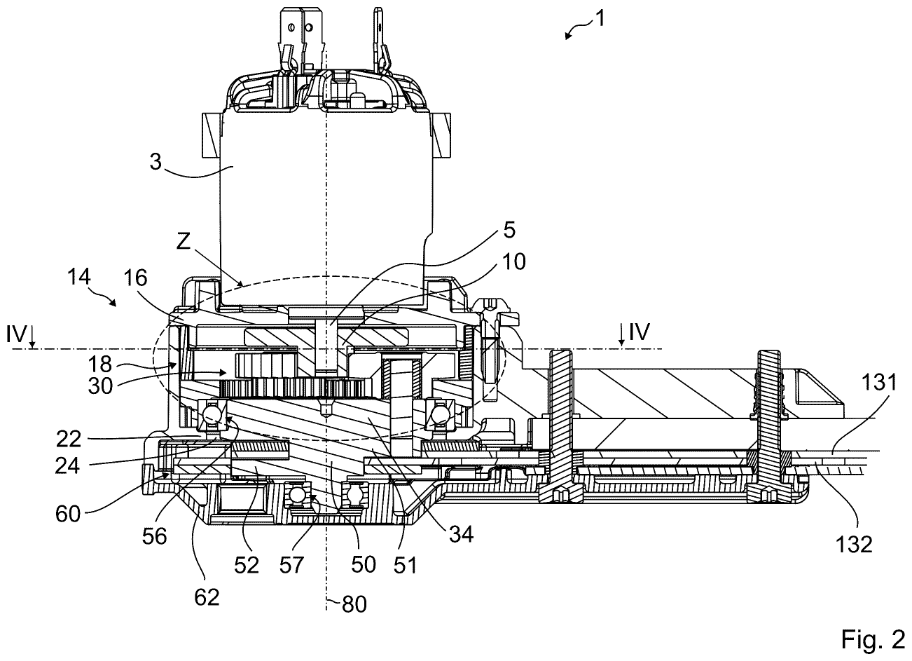

FIG. 2 shows the work tool drive unit 1 with cutting blades 131, 132 of the work apparatus 100 which are arranged thereon. The work tool drive unit 1 includes a gearbox 14 with a pot-shaped gear receiving chamber 18 and a cover 16 which covers the gear receiving chamber 18 in an axial direction. A planetary gear 30 is arranged in the gear receiving chamber 18. An electric motor 3 is arranged on the cover 16, which electric motor is configured as an internal rotor motor in the embodiment and protrudes with its rotor shaft 5 into the gear receiving chamber 18. The drive pinion 10 is arranged fixedly on the rotor shaft 5 of the electric motor 3 for conjoint rotation. The electric motor 3 drives the drive pinion 10 at a drive rotational speed. The drive rotational speed is, in particular, at least 12,000 revolutions per minute, in particular at least 20,000 revolutions per minute. A through opening 24 is configured on a base 22 of the gear receiving chamber 18. An eccentric shaft 50 protrudes through the through opening 24. The eccentric shaft 50 is driven by a planetary carrier 34 of the planetary gear 30 at an output rotational speed. The eccentric shaft 50 is supported at its first end indirectly by the planetary carrier 34 on a first bearing position 56 on the sixth peripheral section 46 of the ring gear 36. The eccentric shaft 50 is supported at its second end on a second bearing position 57. The rotor shaft 5 and the eccentric shaft 50 lie coaxially with respect to a central axis 80 of the planetary gear 30. The rotational axis of the drive pinion 10 forms the central axis 80 of the planetary gear 30.

Cams 51, 52 for driving the cutting blades 131, 132 are arranged on the eccentric shaft 50 between the first bearing position 56 and the second bearing position 57. In the embodiment, a first cam 51 for driving a first cutting blade 131 and a second cam 52 for driving a second cutting blade 132 are arranged on the eccentric shaft 50. In the embodiment, the eccentric shaft 50, the first cam 51, the second cam 52 and the planetary carrier 34 are configured in one part with one another. It is also possible, however, for one or both cams 51, 52 to be configured separately from the eccentric shaft 50 and, instead, to be connected fixedly to it for conjoint rotation. Independently of this or in addition to this, it is possible for the eccentric shaft 50 to be configured separately from the planetary carrier 34 and, instead, to be connected fixedly to it for conjoint rotation. The second bearing position 57 of the eccentric shaft 50 is arranged in a second cover 62. The second cover 62 closes a blade chamber 60. The first cam 51 and the second cam 52 and in each case one drive end, arranged on the circumference thereof, of the first cutting blade 131 and the second cutting blade 132 are situated in the blade chamber 60.

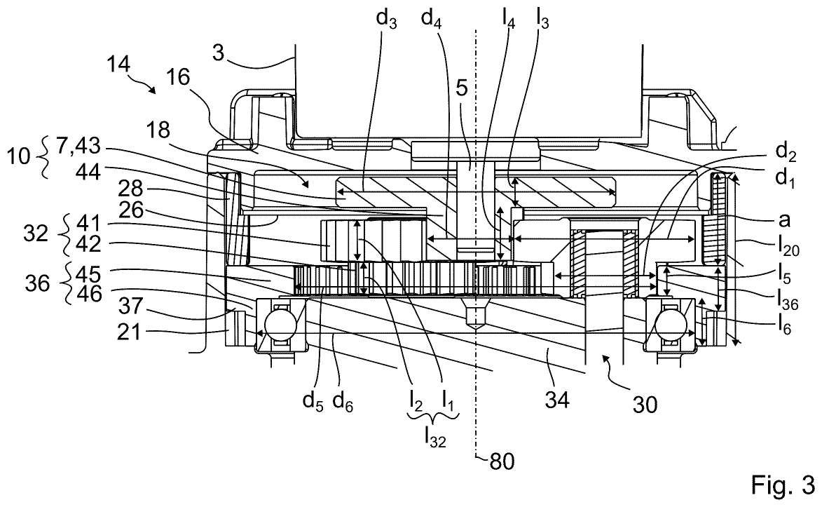

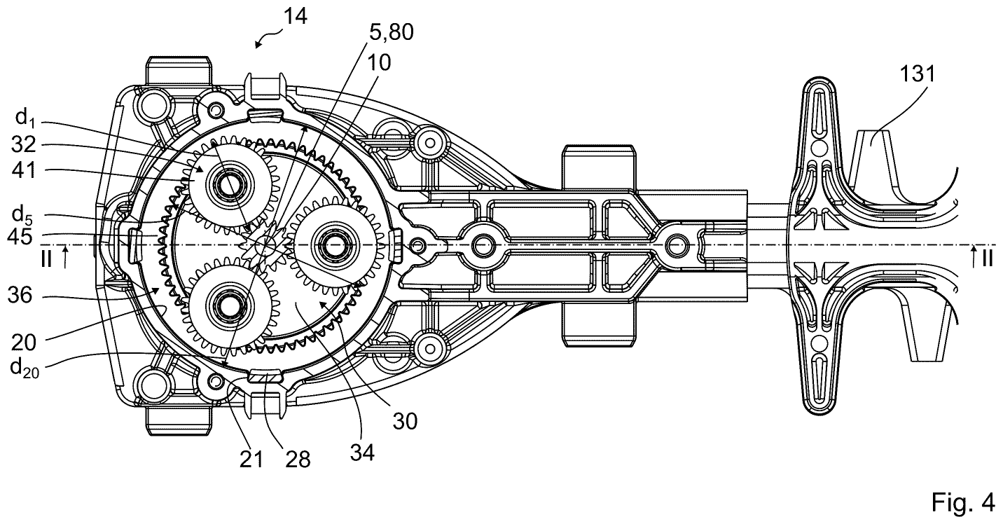

FIG. 3 shows the planetary gear 30 from FIG. 2 in detail. The planetary gear 30 is driven by a drive pinion 10. The drive pinion 10 is seated on the rotor shaft 5 of the electric motor 3. In the embodiment, the planetary gear 30 has three planets 32 (FIG. 4). A different number of planets 32 can also be expedient. The planets 32 each have a first peripheral section 41 and a second peripheral section 42. A first diameter di of the first peripheral section 41 is greater than a second diameter d2 of the second peripheral section 42. The first peripheral section 41 of the planet 32 is driven by the drive pinion 10. The second peripheral section 42 of the planet 32 meshes with a fifth peripheral section 45 of a ring gear 36 of the planetary gear 30. The ring gear 36 has an internal diameter d₅ on the fifth peripheral section 45. The ring gear 36 includes a sixth peripheral section 46, on the internal diameter d₆ of which the first bearing position 56 of the eccentric shaft 50 is configured. Projections 37 are configured on the ring gear 36 on an outer circumference of the ring gear 36, by which projections 37 the ring gear 36 is centered in the gear receiving chamber 18 and is fixed against rotation with respect to the gearbox 14. Grooves 21 (FIG. 4) are arranged in the circumferential wall 20 of the gear receiving chamber 18, into which grooves 21 the projections 37 protrude. The ring gear 36 is fixed in the axial direction by hold-downs 28. The hold-downs 28 bridge an axial spacing a between the cover 16 and an end face of the ring gear 36 which faces the cover. The hold-downs 28 are arranged in the grooves 21 of the gearbox 14. The hold-downs 28 are manufactured from a plastic material in the embodiment. The ring gear 36 is manufactured, in particular, from a plastic material. Even if hold-downs 28 which are configured separately from the ring gear 36 are shown in the embodiment, it is readily possible for them to be of integral configuration with the ring gear. The properties which are described for the separate hold-downs 28 also apply to hold-downs which are configured integrally with the ring gear.

In the embodiment, the drive pinion 10 has a third peripheral section 43 and a fourth peripheral section 44. The fourth peripheral section 44 meshes with the planets 32. The third peripheral section 43 has a diameter d₃ which is increased in comparison with the diameter d₄ of the fourth peripheral section 44, and is configured as an oscillating weight 7. The third peripheral section 43 and the fourth peripheral section 44 are connected fixedly to one another for conjoint rotation. In the embodiment, the third peripheral section 43 and the fourth peripheral section 44 are configured as a component formed from the same material. It can also be provided that the third peripheral section 43 and the fourth peripheral section 44 are joined to one another, in order to form the drive pinion 10. The drive pinion 10 is arranged in the gearbox 14. A thrust washer 26 divides the gear receiving chamber 18 in such a way that the planetary gear 30 and the oscillating weight 7 are arranged on different sides of the thrust washer 26. The oscillating weight 7 is arranged between the cover 16 and the thrust washer 26. The third peripheral section 43 has an axial length l₃ which is arranged completely between the cover 16 and the thrust washer 26. The thrust washer 26 lies on a shoulder of the hold-down 28. The cover 16 has an (in particular, peripheral) collar, against which the thrust washer 26 bears. The thrust washer 26 is clamped, in particular, between the hold-down 28 and the collar.

In the embodiment, the first peripheral section 41 and the second peripheral section 42 of the planet 32 are configured in one piece, in particular from the same material. The planet 32 is produced by a sintering method. In the interior of the planet 32, an anti-friction bearing extends over the first peripheral section 41 and the second peripheral section 42, to which anti-friction bearing the planet 32 is attached rotatably on the planetary carrier 34.

Toothing systems are configured in each case on the first peripheral section 41 and the second peripheral section 42 of the planet 32 and the fourth peripheral section 44, interacting with the former, of the drive pinion 10 and the fifth peripheral section 45 of the ring gear 36.

The number of teeth of the fourth peripheral section 44 lies, in particular, between 7 and 20, very particularly between 10 and 15; in the embodiment, it is 13. The number of teeth of the first peripheral section 41 lies, in particular, between 15 and 40, very particularly between 23 and 33; in the embodiment, it is 28. The number of teeth of the second peripheral section 42 lies, in particular, between 10 and 26, very particularly between 15 and 22; in the embodiment, it is 18. The number of teeth of the fifth peripheral section 45 lies, in particular, between 30 and 90, very particularly between 48 and 72; in the embodiment, it is 61. Here, the numbers of teeth are adapted to one another in such a way that the result is a transmission ratio of the planetary gear 30 of between 7 and 10. In the embodiment, the planetary gear 30 has a transmission ratio of approximately 8.

In the embodiment, the internal diameter d₂₀ (FIG. 4) of the circumferential wall 20 of the gear receiving chamber 18 is approximately 60 mm, and the axial length l₂₀ of the circumferential wall 20 of the gear receiving chamber 18 is approximately 24 mm. Accordingly, the axial length l₂₀ of the circumferential wall 20 is approximately 40% of the internal diameter d₂₀ of the circumferential wall 20. As a result, the gearbox 14 is particularly flat.

The planets 32 have an axial length l₃₂ which corresponds at most to 50% of the first diameter d₁. As a result, the planets 32 are particularly flat. The axial length of the fifth peripheral section 45 of the ring gear 36 is at most 10% of the internal diameter d₅ of the ring gear 36 on the fifth peripheral section 45. As a result, the fifth peripheral section 45 is particularly flat. The ring gear 36 has an axial minimum length l₃₆ for support on the gearbox 14. The axial minimum length l₃₆ is greater than the axial length l₅ of the fifth peripheral section 45. The axial length l₅ of the fifth peripheral section 45 is, in particular, shorter than the axial length l₁ of the first peripheral section 41, the axial length l₂ of the second peripheral section 42, the axial length l₄ of the fourth peripheral section 44 and/or the axial length l₆ of the sixth peripheral section 46. At least one part of the axial length l₆ of the sixth peripheral section 46 contributes to the support on the gearbox 14. The sixth peripheral section 46 of the ring gear 36 surrounds the planetary carrier 34. In this way, the same axial installation space is used particularly efficiently for the support of both the ring gear 36 and the planetary carrier 34 on the gearbox 14. As a result, the planetary gear 30 is of particularly flat configuration.

FIG. 4 shows a part of the work tool drive unit 1 in the viewing direction along the central axis 80 directly below the thrust washer 26. The first peripheral sections 41 of the three planets 32 in the embodiment mesh with the fourth peripheral section 44 of the drive pinion 10. The grooves 21 for receiving the hold-downs 28 are arranged in the circumferential wall 20 of the gearbox 14. Four grooves 21 are provided in the embodiment; a different number of grooves, in particular three, can also be expedient. The grooves 21 are distributed over the circumference of the circumferential wall 20, in particular, at a uniform angular spacing. The first diameter d₁ of the first circumferential section 41 of the planet 32 can be maximized by receiving the hold-downs 28 in the grooves 21, without the planet 32 colliding with the hold-down 28 during circulation.

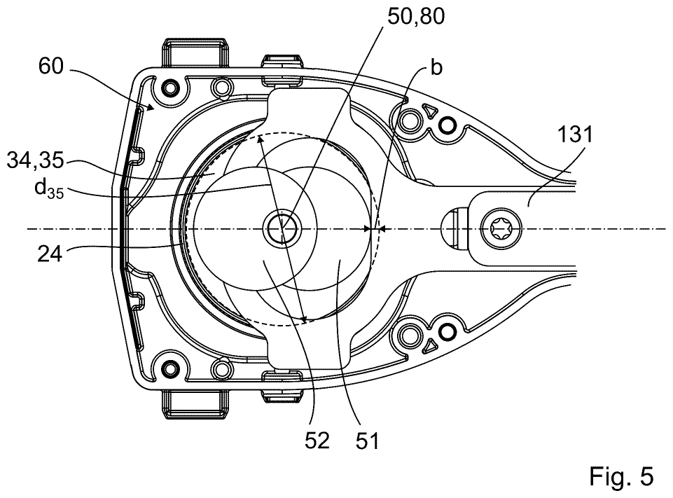

FIG. 5 shows the blade chamber 60 in the viewing direction along the central axis 80 in a partially assembled state of the work tool drive unit 1. The second cover 62 and the second cutting blade 132 are removed. As can be seen, the first cam 51 bears against the drive end of the first cutting blade 131. In the illustration, the first cutting blade 131 is situated in an end position and would again move closer to the central axis 80 in the case of further rotation of the eccentric shaft 50. An end face 35, facing the first cam 51, of the planetary carrier 34 protrudes radially beyond the first cam 51 in every direction. There is a minimum overhang b of the end face 35 with respect to the first cam 51 even in the end positions. As a result, regardless of the position in which the first cam 51 is situated, the end face 35 serves as a supporting surface for the drive end of the first cutting blade 131. The diameter d₃₅ of the end face 35 is illustrated using dashed lines, with the result that it becomes visible that the first cutting blade 131 can always (that is, also in the end positions) be supported on the planetary carrier 34. In the case of jamming of the cutting blade 131, it is therefore reliably ensured that the drive end of the first cutting blade 131 cannot lift up axially from the periphery of the first cam 51. The diameter d₃₅, increased in comparison with the prior art, of the end face 35 of the planetary carrier 34 supports the drive end axially and thus avoids releasing of the drive end from the cam 51. Additional securing means which hold the first cutting blade 131 axially in position and avoid sliding off from the first cam 51 can be dispensed with. The configuration of the planetary carrier 34 with a diameter d₃₅ of the end face 35 which lies radially completely outside the first cam 51 and therefore forms a supporting surface for a drive end of a first cutting blade 131 is an independent inventive concept which can also be implemented independently of the remaining configuration of the planetary gear 30. In particular, a planetary carrier which is configured in this way can also be used in a multiple-stage planetary gear in the last stage, that is, on the gear output side.

The handheld work apparatus can also have cutting blades which, instead of an oscillating translational relative movement, carry out an oscillating rotational relative movement with respect to one another. Here, at least one cutting blade is driven indirectly by the eccentric shaft.

It is understood that the foregoing description is that of the preferred embodiments of the invention and that various changes and modifications may be made thereto without departing from the spirit and scope of the invention as defined in the appended claims.

1. A work tool drive unit for a cutting blade of a handheld work apparatus, the work tool drive unit comprising:
an electric motor configured to rotate a drive pinion at a drive rotational speed;
a gearbox;
a planetary gear arranged in said gearbox and said planetary gear including a single ring gear, a single planetary carrier and planets driven by said drive pinion;
an eccentric shaft driven by said planetary gear at an output rotational speed and being configured to drive at least one cutting tool in an oscillating manner;
said planets each having a first peripheral section and a second peripheral section;
wherein a first diameter of said first peripheral section is greater than a second diameter of said second peripheral section;
wherein said first peripheral section is in engagement exclusively with said drive pinion and said second peripheral section is in engagement exclusively with said ring gear; and,
an oscillating weight connected fixedly to said drive pinion for conjoint rotation.

2. The work tool drive unit of claim 1, wherein said drive pinion has a third peripheral section and a fourth peripheral section; said fourth peripheral section is in engagement with said first peripheral section; said third peripheral section has a diameter increased in comparison with said fourth peripheral section; and said third peripheral section forms said oscillating weight, at least partially.

3. The work tool drive unit of claim 1, wherein said electric motor, said planetary gear and said eccentric shaft are arranged coaxially with respect to one another.

4. The work tool drive unit of claim 1, wherein said gearbox has a pot-shaped gear receiving chamber and a cover; and, said cover covers said gear receiving chamber in an axial direction.

5. The work tool drive unit of claim 4, wherein said electric motor is arranged on said cover.

6. The work tool drive unit of claim 4, wherein said ring gear is at a spacing (a) from said cover; and, said spacing (a) is bridged by a hold-down.

7. The work tool drive unit of claim 1, wherein said ring gear has a fifth peripheral section and a sixth peripheral section; said fifth peripheral section is in engagement with said second peripheral sections of said planets; and, a bearing position for the planetary carrier of said planetary gear is arranged on said sixth peripheral section.

8. The work tool drive unit of claim 1, wherein said planetary gear has a transmission ratio lying in a value range between 4 and 13.

9. The work tool drive unit of claim 1, wherein said gearbox has a cylindrical circumferential wall with an internal diameter (d₂₀) and a length (l₂₀) measured in an axial direction; said length (l₂₀) is at most 50% of said internal diameter (d₂₀); and, said internal diameter (d₂₀) lies radially outside a cam arranged on said eccentric shaft.

10. The work tool drive unit of claim 1, wherein said first peripheral section and said second peripheral section are configured in one piece.

11. A handheld work apparatus comprising a work tool drive unit including:
an electric motor configured to rotate a drive pinion at a drive rotational speed;
a gearbox;
a planetary gear arranged in said gearbox and said planetary gear including a single ring gear, a single planetary carrier and planets driven by said drive pinion;
an eccentric shaft driven by said planetary gear at an output rotational speed and being configured to drive at least one cutting tool in an oscillating manner;
said planets each having a first peripheral section and a second peripheral section;
wherein a first diameter of said first peripheral section is greater than a second diameter of said second peripheral section;
wherein said first peripheral section is in engagement exclusively with said drive pinion and said second peripheral section is in engagement exclusively with said ring gear;
an oscillating weight connected fixedly to said drive pinion for conjoint rotation;
a handle unit for holding and guiding the work apparatus;
an energy source for feeding the electric motor; and,
cutting blades movable relative to one another and of which at least one cutting blade is driven by said eccentric shaft.
